(19) United States
(12) Patent Application Publication
(10) Pub. No.: US 2004/0221281 A1
(43) Pub. Date: Nov. 4, 2004

(54) Compiler apparatus, compiling method, and compiler program

(76) Inventor: Toshio Suganuma, Yokohama-shi (JP)

Correspondence Address: David Aker, 23 Southern Road, Hartsdale, NY, 10530, US

(21) Appl. No.: 10/860,757

(22) Filed: Jun. 3, 2004

(30) Foreign Application Priority Data
Apr. 6, 2003 (JP) 2003-159206

(51) Int. Cl. G06F 9/45

(52) U.S. Cl. 717/151; 717/140

(57) ABSTRACT

To properly select instructions to be optimized in precedence over other instructions, a compiler apparatus, method and program (including a computer code storage medium having the program thereon) that optimizes a target program to be compiled includes an instruction detecting unit for detecting an instruction of a predetermined type as an optimization-target instruction to be optimized in precedence over other instructions in the target program; an instruction set selecting unit for selecting a set of optimization-target instructions, the set being a set of instructions the order of execution of which is determined with respect to the detected optimization-target instruction and being executed before the optimization-target instruction; and an optimizing unit for optimizing the target program so that the optimization-target instruction set is executed more efficiently than the instructions other than the optimization-target instruction set.

### FIELD OF THE INVENTION

The present invention relates to a compiler apparatus, compiling method, compiler program, and storage medium. In particular, the present invention relates to a compiler apparatus, compiling method, compiler program, and storage medium for selecting a higher-priority set of instruction sequences to be optimized.

### BACKGROUND ART

Functions or methods in a program to be compiled include instructions that are frequently executed and instructions that are never or rarely executed. There has been proposed an approach in which a program to be compiled is first executed to measure the execution frequency of each instruction and then those instructions that are frequently executed are optimized first (see Document 1) and an approach in which only those instructions that are frequently executed are complied (see Document 5). According to the latter approach, the compiler can defer the compilation of rarely executed instructions until these instructions are actually required to execute at runtime. Another approach has been proposed in which frequently executed instructions and rarely executed instructions are placed in different pages in memory so that the locality of the code to be executed is increased (see Document 2).

Furthermore, an approach has been proposed in which instructions that are found to be rarely executed from the result of optimizations are excluded from compilation, without measurement of the execution frequency of those instructions (see Documents 3 and 4).

Another approach called on-stack replacement has been proposed which allows the transfer of the execution dynamically from an optimized compiled code to another version of the code during execution (see Document 6).

Another approach has been proposed in which the branch target of a branch instruction in a program is empirically predicted with heuristics based on the form of the runtime program (see Document 7).

Document 1

R. E. Hank et al., “Region-Based Compilation: An introduction and Motivation” (Proceedings of the 28th International Symposium on Microarchitecture, pp.158-168, 1995)

Document 2

K. Pettis et al., “Profile Guided Code Positioning” (Proceedings of ACM SIGPLAN Conference on Programming Languages Design and Implementation, pp.16-27, June 1990)

Document 3

U. Holzle, “Adaptive Optimization for SELF: Reconciling High Performance with Exploratory Programming” (Ph. D thesis, Stanford University, CS-TR-94-1520, August 1994)

Document 4

M. Paleczny et al., “The Java® HotSpot Server Compiler” (Proceedings of USENIX Java® Virtual Machine Research and Technology Symposium, pp.1-12, April 2001)

Document 5

J. Whaley, “Partial Method Compilation using Dynamic Profile Information” (Proceeding of ACM SIGPLAN conference on Object-Oriented Programming, Systems, Languages & Applications, pp.166-179, October 2001)

Document 6

U. Holzle et al., “Debugging Optimized Code with Dynamic Deoptimization” (Proceedings of ACM SIGPLAN Conference on Programming Language Design and Implementation, pp.32-43, June 1992)

Document 7

T. Ball et al., “Branch Prediction for Free” (Proceedings of ACM SIGPLAN Conference on Programming Language Design and Implementation, pp.300-313, June 1993)

### PROBLEM TO BE SOLVED BY THE INVENTION

Compilers in Documents 1, 2, and 5 need to execute a program before compilation to measure the frequency of execution for each instruction execution path. However, the measurement of the execution frequency requires a large amount of time. Therefore, it is impractical for a dynamic compiler, which compiles a program to be compiled at runtime, to measure the execution frequency of each instruction. If a dynamic compiler measures the frequency of execution of all instructions, the start of the actual execution of the program will be delayed, which is inefficient and unacceptable. Even for a static compiler, which compiles a program to be compiled before execution, the program must be optimized without measuring the frequency of execution if the program does not include the function of measuring the execution frequency.

Compilers described in Documents 3 and 4 do not measure the frequency of execution of each instruction. However, only a limited number of instructions can be excluded from compilation. These compilers cannot exploit the bias in execution frequency that is inherent in a target program to be compiled to determine which instructions should be optimized.

The technique described in Document 7 predicts the branch target of a branch instruction from the pattern of the execution program based on experimental probabilities. This technique does not require the measurement of the frequency of execution of each instruction. However, predictions by this technique can be incorrect for many programs with a high probability of error (10% or more). Therefore, this technique cannot practically be used for determining instructions to be excluded from compilation target.

Therefore an objective of the present invention is to provide a compiler apparatus, compiling method, compiler program and a storage medium that solve these problems. The objective is achieved by the combination of features set forth in the independent Claims herein. The dependent Claims define preferable, specific embodiments of the present invention.

### SUMMARY OF THE INVENTION

According to a first embodiment of the present invention, there are provided a compiler apparatus that optimizes a target program to be optimized, a compiling method using the compiler apparatus, a compiler program implemented as the compiler apparatus, and a storage medium on which the compiler program is stored, the compiler apparatus comprising: an instruction detecting unit for detecting instructions of a predetermined type as optimization-target instructions to be optimized in precedence over other instructions in the target program; an instruction selecting unit for selecting a set of optimization-target instructions that are executed in an order determined with respect to the detected optimization-target instructions and are executed prior to the optimization-target instructions; and an optimizing unit for optimizing the target program so that the rate of improvement in execution speed for the set of the optimization-target instructions by optimization becomes higher than the rate of improvement in execution speed for instructions other than the optimization-target instructions by optimization.

The summary of the invention provided above does not enumerates all the required features of the present invention, and sub-combinations of the features fall in the scope of the present invention. However, some of these are ser forth below:

According to the embodiments and variations described below, the following compiler apparatus, compiling method, compiler program, and storage medium are implemented.

(1) A compiler apparatus that optimizes a target program to be compiled, comprising: an instruction detecting unit for detecting an instruction of a predetermined type as an optimization-target instruction to be optimized in precedence over other instructions in the target program; an instruction set selecting unit for selecting a set of optimization-target instructions, the set being a set of instructions the order of execution of which is determined with respect to the detected optimization-target instruction and being executed before the optimization-target instruction; and an optimizing unit for optimizing the target program so that the rate of improvement in speed of execution of the optimization-target instruction set by optimization becomes higher than the rate of improvement in speed of execution of a set of instructions other than the optimization-target instruction set by optimization.

(2) The compiler apparatus according to item 1, wherein: the target program includes at least one function; the instruction detecting unit detects as the optimization-target instruction a function end instruction that ends the function; and the instruction set selecting unit selects as the optimization-target instruction set a set of instructions that are executed before the optimization-target instruction in said function.

(3) The compiler apparatus according to item 1, wherein: the instruction detecting unit further detects an instruction of another predetermined type as an excluded-from-optimization instruction to be excluded from a target to be optimized in precedence over other instructions; the instruction set selecting unit selects as the optimization-target instruction set a set of instructions that have not been selected as the excluded-from-optimization instruction from among instructions the order of execution of which is determined with respect to the optimization-target instruction and that are executed before the optimization-target instruction.

(4) The compiler apparatus according to item 3, wherein: if a predetermined exception generation condition is met, the target program proceeds to an exception catch process appropriate to the type of the exception generation condition; and the instruction detecting unit detects as the excluded-from-optimization instruction the exception generating instruction that causes the target program to proceed to the exception catch process during execution of the target program.

(5) The compiler apparatus according to item 3, wherein: if a predetermined exception generating condition is met, the target program proceeds to an exception catch process appropriate to the type of the exception generating condition; and the instruction detecting unit detects as the excluded-from-optimization instruction any of instructions included in the exception catch process.

(6) The compiler apparatus according to item 3, wherein the target program includes a data reference instruction that refers to data; if the data reference instruction is executed in a reference-unsolved state in which the storage location of the data to be referred to has not been analyzed, the data reference instruction is translated into a direct reference instruction including information indicating the storage location of the data to be referred to; and the instruction detecting unit detects the data reference instruction in the reference-unsolved state as the excluded-from-optimization instruction.

(7) The compiler apparatus according to item 3, wherein: the target program includes a processing instruction that has a predetermined parameter as an input and performs a process according to the parameter; the compiler apparatus further comprises a processing instruction duplicating unit for generating, in place of the processing instruction, a processing-on-condition-met instruction that performs the same process as the processing instruction and is executed faster than the processing instruction if the parameter meets a predetermined condition and a processing-on-condition-unmet instruction that is executed if the parameter does not meet the predetermined condition; and the instruction detecting unit detects the processing-on-condition-unmet instruction as the excluded-from-optimization instruction.

(8) The compiler apparatus according to item 3, wherein the instruction set selecting unit comprises:

an execution information propagating unit that detects, as an excluded-from-optimization instruction, an instruction that is executed immediately before the excluded-from-optimization instruction, and detects, as an optimization-target instruction, an instruction that is executed immediately before the optimization-target instruction; and

a branch instruction propagating unit that detects, as an optimization-target instruction, a branch instruction any of the branch target instructions of which is the optimization-target instruction, and detects, as excluded-from-optimization instruction, a branch instruction none of the branch target instructions of which is the optimization-target instruction and any of the branch target instructions is the excluded-from-optimization instruction,; and

the compiler apparatus selects, as the optimization-target instruction set, a set of the optimization-target instructions detected by applying the process performed by the execution information propagating unit and the branch instruction propagating unit to the instructions in the target program one by one.

(9) The compiler apparatus according to item 3, further comprising an execution frequency information measuring unit that measures the frequency of execution of at least some of the instructions included in the target program by executing the target program; wherein if the frequency of execution of the detected excluded-from-optimization instruction that is measured by the execution frequency information measuring unit is higher than a predetermined first frequency, the instruction set selecting unit selects the excluded-from-optimization instruction as the optimization-target instruction, and if the frequency of execution of the detected optimization-target instruction that is measured by the execution frequency information measuring unit is lower than a predetermined second frequency lower then the first frequency, the instruction set selecting unit selects the optimization-target instruction as the excluded-from-optimization instruction.

(10) The compiler apparatus according to item 1, wherein the instruction set selecting units follows an execution sequence backward from the detected optimization-target instruction to select the optimization-target instruction set; and the optimizing unit optimizes the target program so that the rate of improvement in speed of execution of the selected optimization-target instruction set by optimization of an execution path becomes higher the rate of improvement in speed of execution of the instructions other than the optimization-target instructions.

(11) The compiler apparatus according to item 1, wherein, in order to compile the target program so that the rate of improvement in speed of execution of the optimization-target instruction set by optimization becomes higher than the rate of improvement in speed of the instructions other than the optimization-target instruction set by optimization, the optimizing unit compiles the target program excluding the excluding-from-optimization instruction set other than the optimization-target instruction set in the target program, causes the target program to be executed and, if execution of the excluded-from-optimization instruction set becomes required as a result of execution of the optimization-target instruction set, compiles the excluded-from-optimization instruction set.

(12) The compiler apparatus according to item 1, wherein the target program is executed by a device including a main memory having a plurality of pages and a virtual memory allocating unit for allocating each of the plurality of pages to an virtual address accessible to a user;

the optimizing unit places the optimization-target instruction set in one of the plurality of page that is different from a page in which the instructions other than the optimization-target instruction set are placed and thereby optimizes the target program so that the rate of improvement in speed of execution of the optimization-target instruction set by optimization becomes higher than the rate of improvement in speed of execution of instructions other than the optimization-target instruction set by optimization.

(13) The compiler apparatus according to item 1, wherein, in order to compile said target program so that the rate of improvement in speed of execution of the optimization-target instruction set by optimization becomes higher than the rate of improvement in speed of the instructions other than the optimization-target instruction set by optimization, the optimizing unit performs in-line expansion in which an operation in a function called from an optimization-target instruction set in a calling function in the target program excluding the excluded-from-optimization instruction set is included in an optimization-target instruction set in the calling function and is executed.

(14) The compiler apparatus according to item 1, wherein the instruction detecting unit further detects instructions of another predetermined type, as sub-optimization-target instructions to be optimized not in precedence over the optimization-target instructions but in precedence over the excluded-from-optimization instructions that are excluded from the target to be optimized in precedence;

the instruction set selecting unit selects, as the optimization-target instruction set, a set of instructions the order of execution of which is determined with respect to the optimization-target instructions and the sub-optimization-target instructions and that are executed before the optimization-target instructions and the sub-optimization-target instructions, and selects, as a set of sub-optimization-target instructions, a set of instruction the order of execution of which is determined with respect to the sub-optimization-target instructions but not determined with respect to the optimization-target instructions; and

the optimizing unit optimizes the target program so that the rate of improvement in speed of execution of the sub-optimization-target instruction set by optimization becomes lower than the rate of improvement in speed of execution of the rate of improvement in speed of execution of the optimization-target instruction set by optimization but higher than the rate of improvement in speed of execution of the excluded-from-optimization instructions by optimization.

(15) The compiler apparatus according to item 14, further comprising an execution frequency information measuring unit for measuring the frequency of execution of at least some of instructions in the target program by executing the target program; wherein the instruction detecting unit detects, as the sub-optimization target instructions, instructions of another predetermined type in the target program on further condition that the execution frequency which is measured by the execution frequency information measuring unit is within a predetermined range.

(16) A compiler apparatus that optimizes a target program to be compiled, comprising: an instruction detecting unit for detecting an instruction of a predetermined type that is to be excluded from targets to be optimized in precedence over other instructions in the target program; an instruction set selecting unit for selecting a set of excluded-from-optimization instructions to be excluded from targets to be optimized in precedence by sequentially selecting the instructions while following an execution sequence backward from the detected optimization-target instruction until an instruction predetermined as a target of optimization is found; an optimizing unit for optimizing the target program so that the rate of improvement in speed of execution of a set of instructions other than the excluded-from-optimization instructions by optimization becomes higher than the rate of improvement in speed of execution of the excluded-from-optimization instructions by optimization.

(17) A compiling method that optimized a target program to be compiled, comprising the steps of: detecting an instruction of a predetermined type as an optimization-target instruction to be optimized in precedence over other instructions in the target program; selecting a set of optimization-target instructions, the set being a set of instructions the order of execution of which is determined with respect to the detected optimization-target instruction and being executed before the optimization-target instruction; and optimizing the target program so that the rate of improvement in speed of execution of the optimization-target instruction set by optimization becomes higher than the rate of improvement in speed of execution of a set of instructions other than the optimization-target instruction set by optimization.

(18) A compiling method that optimized a target program to be compiled, comprising the steps of: detecting an instruction of a predetermined type as an excluded-from-optimization instruction to be excluded from targets to be optimized in precedence over other instructions in the target program; selecting step of selecting a set of excluded-from-optimization instructions to be excluded from targets to be optimized in precedence by sequentially selecting the instructions while following an execution sequence backward from the detected optimization-target instruction until an instruction predetermined as a target of optimization is found; optimizing the target program so that the rate of improvement in speed of execution of a set of instructions other than the excluded-from-optimization instructions by optimization becomes higher than the rate of improvement in speed of execution of the excluded-from-optimization instructions.

(19) A compiler program for causing a computer to function as a compiler apparatus that optimizes a target program to be compiled; the compiler program causing the computer to function as: an instruction detecting unit for detecting an instruction of a predetermined type as an optimization-target instruction to be optimized in precedence over other instructions in the target program; an instruction set selecting unit for selecting a set of optimization-target instructions, the set being a set of instructions the order of execution of which is determined with respect to the detected optimization-target instruction and being executed before the optimization-target instruction; and an optimizing unit for optimizing the target program so that the rate of improvement in speed of execution of the optimization-target instruction set by optimization becomes higher than the rate of improvement in speed of execution of a set of instructions other than the optimization-target instruction set by optimization.

(20) The compiler program according to item 19, the instruction detecting unit further detects an instruction of another predetermined type as excluded-from-optimization instruction to be excluded from a target to be optimized in precedence over other instructions; the instruction set selecting unit selects as the optimization-target instruction set a set of instructions that have not been selected as the excluded-from-optimization instruction from among instructions the order of execution of which is determined with respect to the optimization-target instruction and that are executed before the optimization-target instruction.

(21) A compiler program for causing a computer to function as a compiler apparatus that optimizes a target program to be compiled; the compiler program causing the computer to function as: an instruction detecting unit for detecting an instruction of a predetermined type as an excluded-from-optimization instruction to be excluded from targets to be optimized in precedence over other instructions in the target program; an instruction set selecting unit for selecting a set of excluded-from-optimization instructions to be excluded from targets to be optimized in precedence by sequentially selecting the instructions while following an execution sequence backward from the detected excluded-from-optimization instruction until an instruction predetermined as a target of optimization is found; an optimizing unit for optimizing the target program so that the rate of improvement in speed of execution of a set of instructions other than the excluded-from-optimization instructions by optimization becomes higher than the rate of improvement in speed of execution of the excluded-from-optimization instructions by optimization.

The invention is also directed to a storage medium containing a computer program according to any of items 19 to 21.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 shows a functional block diagram of a compiler apparatus 10, in accordance with the invention;

FIG. 2 shows a flowchart of a process performed in the compiler apparatus 10;

FIG. 3 shows a flowchart of a process performed at S230 in FIG. 2;

FIG. 4 shows a flowchart of a process performed at S240 in FIG. 2;

FIG. 5 shows a flowchart of a process performed at S410 in FIG. 4;

FIG. 6 shows a flowchart of a process performed at S250 in FIG. 2;

FIG. 7 shows an example of a target program;

FIG. 8 shows a control flow of the target program shown in FIG. 7;

FIG. 9 is a diagram illustrating a variation; and

FIG. 10 shows an example of a hardware configuration of the compiler apparatus 10.

### DETAILED DESCRIPTION OF THE PREFERRED EMBODIMENT

The present invention will be described with respect to embodiments thereof. However, the embodiments described below do not limit the present invention according to the Claims of the present invention and not all combinations of the features described in the embodiments are essential to the solution according to the present invention.

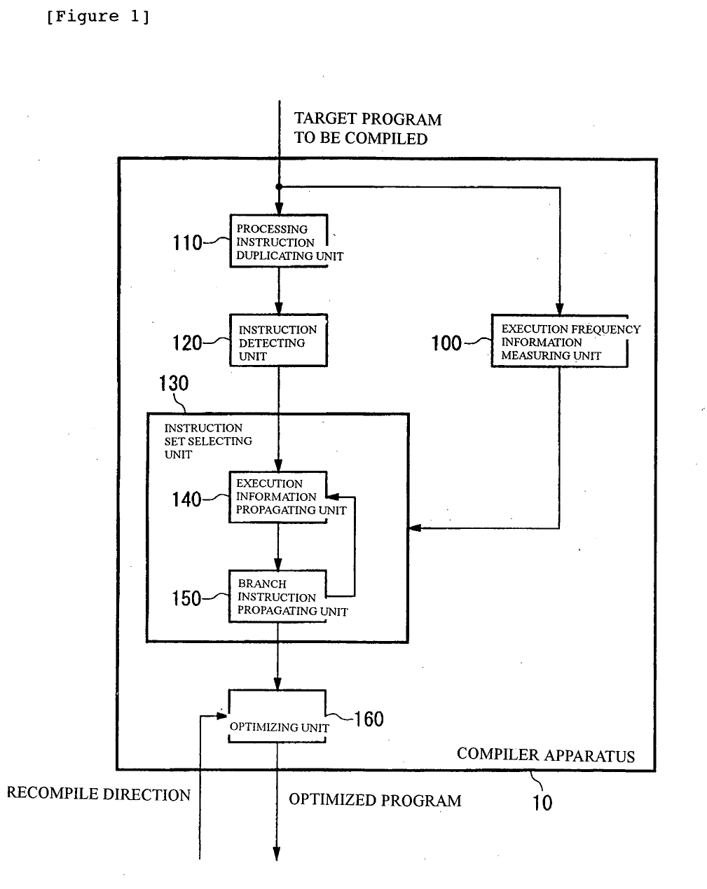

FIG. 1 shows a functional block diagram of a compiler apparatus 10. The compiler apparatus 10 appropriately selects instructions to be optimized in precedence over other instructions from a program to be complied in order to improve the efficiency of execution of the compiled program and reduce the time required for compilation.

The compiler apparatus 10 comprises an execution frequency information measuring unit 100, a processing instruction duplicating unit 110, an instruction detecting unit 120, an instruction set selecting unit 130, and an optimization unit 160. The execution frequency information measuring unit 100 executes a target program to be complied prior to compilation to measure the frequency of execution for at least some of the instructions included in the target program and sends the measurements to the instruction set selecting unit 130. For example, the execution frequency information measuring unit 100 may be a part of an interpreter that sequentially interprets instructions in a target program to be complied and executes interpreted instructions to measure the frequency of execution of the instructions. Alternatively, the execution frequency information measuring unit 100 may execute a program that was compiled beforehand by another method to measure the frequency of execution of the instructions. The execution frequency information measuring unit 100 is not an essential component of this embodiment. This means that the execution frequency information measuring unit 100 may be omitted from the compiler apparatus 10. The execution frequency information measuring unit 100 allows the compiler apparatus 10 to select instructions more appropriately.

A target program in the present embodiment is an intermediate representation produced by applying a predetermined translation of a source program written by a user. Specifically, it may be an intermediate representation written in bytecode of the Java o language, or in RTL (Register Transfer Language). The target program may have had applied to it some optimizations such as method inclining beforehand. Alternatively, the program may be a source program written by a user.

An instruction may be a unit of processing in the intermediate representation described above, for example. Alternatively, an instruction may be a set of instructions in an intermediate representation, or statements in a source program, or an instruction in an apparatus executing a target program. Alternatively, an instruction may be a set of instructions consisting of one or more instructions. For example, an instruction may be a basic block that is a set of instructions executed sequentially without changing a control flow. More specifically, a basic block is an instruction set consisting of instructions that cannot be a branch target or a branch source, except for its entry and exit instructions.

The processing instruction duplicating unit 110 receives a target program, and then detects a processing instruction that has a predetermined parameter as an input and that performs processing according to the input parameter. Then the processing instruction duplicating unit 110 generates two instructions, which will be described below, that replaces the processing instruction, and sends the generated target program to the instruction detecting unit 120. The processing instruction duplicating unit 110 first generates a processing-on-condition-met instruction that performs the same processing as the detected instruction and is executed faster than the original instruction if the input parameter meets a predetermined condition. The processing instruction duplicating unit 110 then generates a processing-on-condition-unmet instruction that performs the same processing as the detected instruction and is executed if the input parameter does not meet the predetermined condition.

For example, the processing instruction duplicating unit 110 detects a loop as a processing instruction and performs loop versioning to generate a fast processing loop that is executed if an input parameter meets a predetermined condition, for example the condition that access to an array variable is within a predetermined range and the loop can be executed fast without performing exception checks, and a normal processing loop that is executed normally if the condition is not met. In another example, the processing instruction duplicating unit 110 may detect as a processing instruction a class reference instruction that refers to data in a predetermined class. In that case, the processing instruction duplicating unit 110 may perform devirtualization that generates, instead of the class reference instruction, a static reference instruction that can be executed faster than the class reference instruction if the hierarchical location of the predetermined class is determined and a normal reference instruction that is executed if the hierarchical location is not determined.

The instruction detecting unit 120 receives a target program from the processing instruction duplicating unit 110 and detects instructions of predetermined types as optimization-target instructions to be optimized in precedence over other instructions in the target program. The instruction detecting unit 120 also detects instructions of other predetermined types as excluded-from-optimization instructions to be excluded from the optimization targets in precedence over other instructions. The instruction detecting unit 120 then sends the target program to the instruction set selecting unit 130 along with the results of the detection.

The instruction set selecting unit 130 receives the target program from the instruction detecting unit 120 along with the results of detection of the optimization-target instructions and excluded-from-optimization instructions. The instruction set selecting unit 130 selects, as an optimization-target instruction set, a set of instructions that have not been selected as excluded-from-optimization instructions from among the instructions whose execution order is determined with respect to the optimization-target instructions and that are executed prior to the optimization-target instructions. The instruction set selecting unit 130 also includes in the set of optimization-target instructions those instructions whose execution frequency, measured by the execution frequency information measuring unit 100, is higher than a first predetermined threshold from among the excluded-from-optimization instructions. The instruction set selecting unit 130 selects, as excluded-from-optimization instruction, detected optimization-target instructions whose execution frequency, measured by the execution frequency information unit 100, is lower than a second predetermined threshold that is lower than the first threshold. The instruction set selecting unit 130 then sends the target program to the optimizing unit 160 along with the results of selection of optimization-target instructions.

Specifically, the instruction set selecting unit 130 has an execution information propagating unit 140 and a branch instruction propagating unit 150. The execution information propagating unit 140 detects an instruction that is executed immediately before an excluded-from-optimization instruction as an excluded-from-optimization instruction and detects an instruction that is executed immediately before an optimization-target instruction as an optimization-target instruction. The branch instruction propagating unit 150 detects, as an optimization-target instruction, a branch instruction where any of the branch target instructions is an optimization-target instruction and detects, as a excluded-from-optimization instruction, a branch instruction where none of the branch target instructions is an optimization-target instruction and any of the branch target instructions is a excluded-from-optimization instruction. The instruction set selecting unit 130 repeatedly applies the processes by the execution information propagating unit 140 and the branch instruction propagating unit 150 to each of the instructions in the target program to determine a set of optimization-target instructions. That is, the instruction set selecting unit 130 selects the set of optimization-target instructions by following the execution sequence backward from an optimization-target instruction detected by the instruction detecting unit 120.

The optimizing unit 160 optimizes the target program based on the result of selection received from the instruction set selecting unit 130 so that the set of optimization-target instructions is executed more efficiently than the instructions other than the set of the optimization-target instructions. Then the optimizing unit 160 outputs the optimized program. In particular, the optimizing unit 160 optimizes the target program based on the result of selection received from the instruction set selecting unit 130 so that the rate of improvement in execution speed for the set of optimization-target instructions by optimization becomes higher than the rate of improvement in execution speed for the set of instructions other than the optimization-target instructions by optimization.

For example, the optimizing unit 160 compiles the set of optimization-target instructions, excluding the excluded-from-optimization instructions in the target program, then executing the target program. Then, as a result of the execution of the set of optimization-target instructions, if the optimizing unit 160 detects that the excluded-from-optimization instructions need to be executed, from a recompilation direction from an instruction embedded in the execution code, the optimizing unit 160 complies the set of the excluded-from-optimization instructions. For example, the optimizing unit 160 may use the Region-Based Compilation technique (see Document 1) and the on-stack replacement technique (see Document 6) to compile the target program. As described above, optimization of a target program improves the execution speed of optimization-target instructions compared with that prior to optimization. Because the target program is optimized so that the optimization target programs can be executed more efficiently, the rate of improvement in execution speed of excluded-from-optimization instructions by the optimization is lower than that of the optimization-target instructions.

As described above, the compiler apparatus 10 determines instructions that are likely to be executed frequently and detects each of those instructions as an optimization-target instruction. The compiler apparatus 10 then selects optimization-target instructions by following the execution sequence backward from the optimization-target instructions, and optimizes them in precedence over other instructions. Thus, the compiler apparatus 10 can appropriately select optimization-target instructions even if the frequencies of execution of all instructions cannot be measured beforehand.

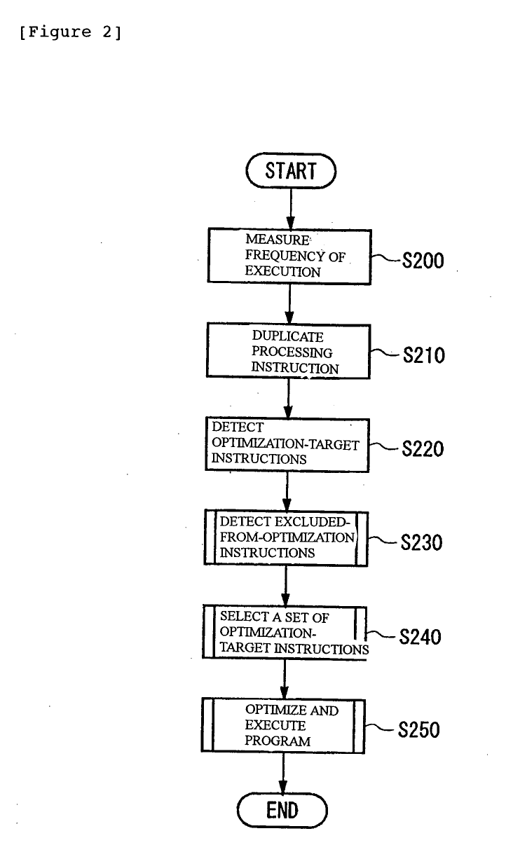

FIG. 2 shows a flowchart of a process performed in the compiler apparatus 10. Before compilation, the execution frequency information measuring unit 100 executes a target program to be compiled to measure the frequency of execution for at least some of instructions included in the target program (step S200). Hereinafter “step” is omitted, such as S200 for step S200. The processing instruction duplicating unit 110 detects an instruction that performs a processing according to an input parameter, and performs processing instruction duplication in which a processing-on-condition-met instruction and a processing-on-condition-unmet instruction are generated from the original processing instruction (S210).

The instruction detecting unit 120 receives the target program from the processing instruction duplicating unit 110 and detects instructions of predetermined types as optimization-target instructions to be optimized in precedence over other instructions in the target program (S220). For example, the instruction detecting unit 120 detects, as an optimization-target instruction, a function returning instruction (for example, a bytecode such as OPC_IRETURN) that terminates a function included in the target program.

The instruction detecting unit 120 also detects instructions of another predetermined types in the target program as excluded-from-optimization instructions to be excluded from the optimization targets in precedence over other instructions (S230). Then, the instruction set selecting unit 130 selects, as an optimization-target instruction set, a set of instructions that have not been selected as excluded-from-optimization instructions from among the instructions whose execution order is determined with respect to the optimization-target instructions and that are executed prior to the optimization-target instructions (S240).

The “execution order is determined” means that the order of execution within a given function or method, for example, is determined. When examining whether or not the execution order is determined, the instruction set selecting unit 130 preferably excludes a loop back edge which indicates the end of a loop and control is returned to the top of the loop. In particular, the instruction set selecting unit 130, without considering the back edge of the loop, selects as optimization-target instructions a set of instructions that have not been selected as excluded-from-optimization instructions from among the instructions whose execution order is determined with respect to optimization-target instructions and that are executed prior to the optimization-target instructions.

The optimizing unit 160 optimizes the target program so that the rate of improvement in execution speed for the optimization-target instructions by optimization becomes higher than the improvement in execution speed for the excluded-from-optimization instructions by optimization (S250). Thus, the optimizing unit 160 can optimize the target program so that the set of optimization-target instructions are executed more efficiently than the excluded-from-optimization instructions.

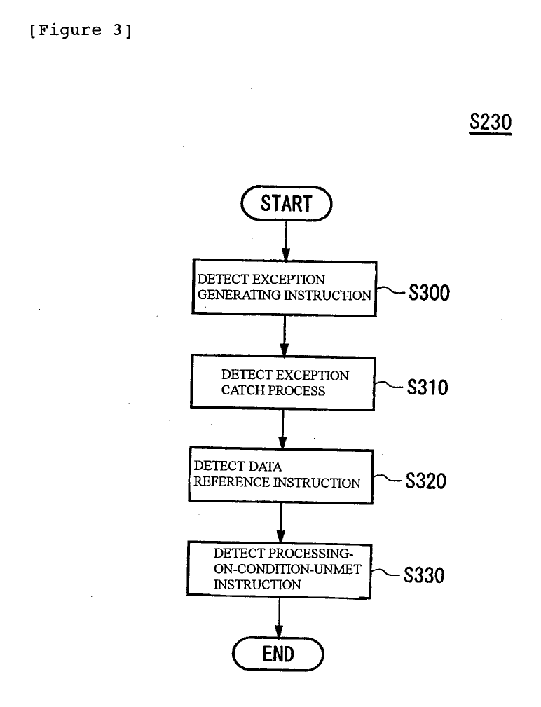

FIG. 3 shows a flowchart of a process performed at S230 shown in FIG. 2. The target program has an exception handling function that, if a predetermined exception condition is met, catches an exception according to the type of the exception condition. The instruction detecting section 120 detects an exception generating instruction that transfers control to an exception catch as an excluded-from-optimization instruction (S300). The instruction detecting unit 120 also detects any instructions that are included in an exception catch process as excluded-from-optimization instruction (S310).

For example, if a target program is written in Java® language, the exception handling is Exception Handling, the exception catch process is an Exception Handler (a catch clause or finally clause), and the exception generating instruction is a throw instruction (for example OPC_ATHROW bytecode). The instruction detecting unit 120 detects, as an excluded-from-optimization instruction, an instruction that is a data reference instruction that refers to data and whose reference is unresolved, that is, the storage location of the data is unresolved (S320). A data reference instruction is an instruction that is translated into a direct reference instruction containing information indicating the storage location of referenced data if the data reference instruction is executed in a reference-unresolved state in which the referenced data is not yet resolved.

For example, a data reference instruction in Java language is an instruction that refers to data or a method in a class. The reference-unresolved state is a state before the storage location of a class having the reference data is identified through the analysis of a class hierarchy that represents inheritances between classes (for example, an uninitialized state or unresolved state). For example, a data reference instruction executed by the execution frequency information measuring unit 100 has been translated into a direct reference instruction before compilation. Therefore, the instruction detecting unit 120 detects a data reference instruction whose reference is unresolved, as an instruction that has not been executed by the execution frequency information measuring unit 100 and is likely to be executed infrequently.

Then, the instruction detecting unit 120 detects a processing-on-condition-unmet instruction as a excluded-from-optimization instruction (S330).

In this way, the instruction detecting unit 120 selects instructions of predetermined types that are likely to be executed infrequently, as excluded-from-optimization instructions to be excluded from the optimization targets in precedence over other instructions. Instructions of predetermined types may be instructions having predetermined operand codes that identify the operations of the instructions. This means that the instruction detecting unit 120 may regard an instruction having a predetermined operand code as instructions of a predetermined type, even if a parameter input to the instruction is not a predetermined parameter.

In general, exceptions rarely occur. However, in some cases, exceptions can be frequently raised. In such a case, the compiler apparatus 10 preferably analyzes frequently throwing exceptions to exclude them from excluded-from-optimization instructions.

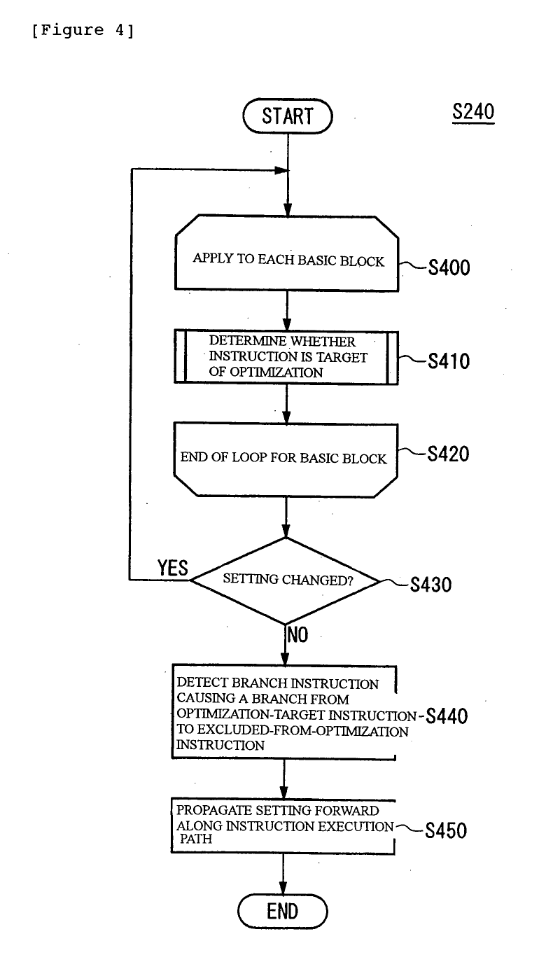

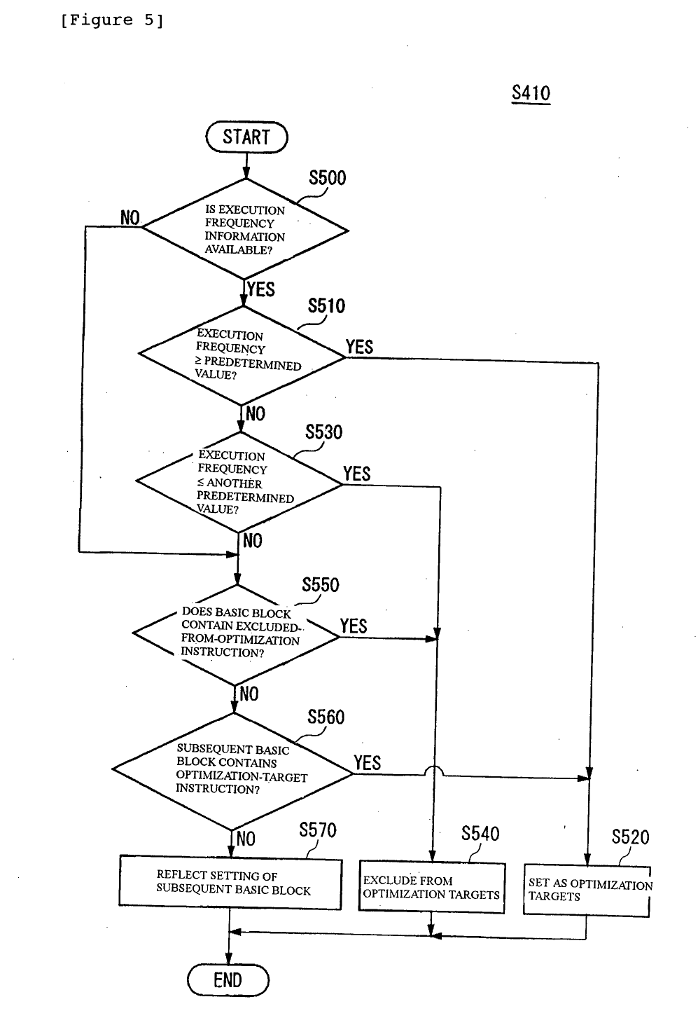

FIG. 4 shows a flowchart of a process performed at S240 shown in FIG. 2. FIG. 5 shows a flowchart of a process performed S410 shown in FIG. 4. In FIGS. 4 and 5, the target program is divided into basic blocks, which is an example of instructions according to the present invention. The instruction set selecting unit 130 applies the following process to each basic block (S400).

The instruction set selecting unit 130 performs the following process in order to determine whether it should select instructions in a basic block as an optimization-target instruction (S410). If the frequency of execution of a basic block has been measured by the execution frequency information measuring unit 100 (S500: YES) and the measured frequency of execution of the basic block is higher than or equal to the first predetermined threshold (S510: YES), the instruction set selecting unit 130 selects instructions in the basic block as targets of optimization (S520). On the other hand, if the frequency of execution of the basic block is lower than the first predetermined threshold (S510: NO), then the instruction set selecting unit 130 determines whether or not the frequency of execution of the basic block is lower or equal to the second predetermined threshold that is lower than the first threshold, (S530). If it is lower than or equal to the second threshold (S530: YES), the instruction set selecting unit 130 excludes the instructions in the basic block from optimization targets and selects them as excluded-from-optimization instructions (S540).

If the frequency of execution of the basic block has not been measured by the execution frequency information measuring unit 100 (S500: NO) or if the frequency of execution of the basic block is higher than the second threshold (S530: NO), the instruction set selecting unit 130 determines whether or not the basic block contains an excluded-from-optimization instruction (S550). Thus, if the frequency of execution of some instructions can be measured, the compiler apparatus 10 can determine target instructions to be optimized, on the basis of the measured frequency of execution.

If the basic block contains an excluded-from-optimization instruction (S550: YES), the instruction set selecting unit 130 selects the instructions in the basic block as excluded-from-optimization instructions (S540). Thus, the basic block can be excluded from optimization even if the subsequent basic block is a block to be optimized. On the other hand, if the basic block does not contain an excluded-from-optimization instruction (S550: NO), the instruction set selecting unit 130 determines whether the subsequent basic block that is to be executed immediately after the basic block of interest contains an optimization-target instruction (S560).

If one of the subsequent basic blocks that are to be executed immediately after the basic block of interest contains an optimization-target instruction (S560: YES), the instruction set selecting unit 130 selects the instructions in the basic block of interest as target instructions to be optimized (S520). On the other hand, if any of the subsequent basic blocks that are to be executed immediately after the basic block of interest does not contain an optimization-target instruction (S560: NO), the instruction set selecting unit 130 reflects a setting of the subsequent basic blocks that indicates whether or not it contains an excluded-from-optimization instruction in the setting of the current basic block (S570). The instruction set selecting unit 130 applies this process to the basic blocks one by one (S420).

If the setting of any of the basic blocks in the target program that indicates that the instructions in that basic block are selected as optimization-target instructions or excluded-from-optimization instructions is changed (S430: YES), the instruction set selecting unit 130 returns to S400. On the other hand, if the setting of all of the basic blocks in the target program that indicates the instructions in that basic block are selected as optimization-target instructions or excluded-from-optimization instructions is not changed (S430: NO), the instruction set selecting unit 130 traverses execution sequence of the target program forward from entry point to detect an instruction that branches from an optimization-target instruction to an excluded-from-optimization instruction (S440). That is, the detected branch instruction is the boundary point at which control is transferred from an optimization-target instruction to an excluded-from-optimization instruction.

The instruction set selecting unit 130 then propagates a flag indicating that the instruction is an optimization-target instruction or an excluded-from-optimization instruction forward along the execution sequence, starting from the detected boundary branch instruction (S450) to detect the merge point where the set of excluded-from-optimization instructions merges the set of optimization-target instructions. Thus, the instruction set selecting unit 130 can identify the end point of the set of excluded-from-optimization instructions.

In this way, the compiler apparatus 10 propagate the setting indicating whether one instruction is an optimization-target instruction or an excluded-from-optimization instruction to the immediately preceding instruction to be executed before that instruction. The compiler apparatus 10 repeats the propagation until it encounters no change in the setting. Thus, the compiler apparatus 10 can select a set of optimization-target instructions by selecting the instructions one by one as it traverses the execution sequence backward from a detected optimization-target instruction. In addition, the compiler apparatus 10 can select a set of excluded-from-optimization instructions by selecting the instructions one by one as it traverses the execution sequence backward from a detected excluded-from-optimization instruction until it detects an instruction predetermined as a target of optimization, for example until it encounters an instruction that has been selected by the instruction set selecting unit 130 as an optimization-target instruction.

In doing so, the compiler apparatus 10 selects optimization-target instructions that actually have a measured execution frequency higher than a predetermined threshold value, in precedence over the other instructions. Accordingly, if the actual frequencies of execution for some of instructions can be measured, the measured frequencies can be used effectively. For example, if the frequency of execution for only some of the functions in a target program has been measured and the optimization of inline expansion has been performed in which one function is inlined into another function to generate a new function after the measurement of execution frequencies, then these exist both instructions that have the execution frequency information and instructions that do not have the execution frequency information within a target program. Even in such a case, the compiler apparatus 10 can use the measured execution frequency effectively.

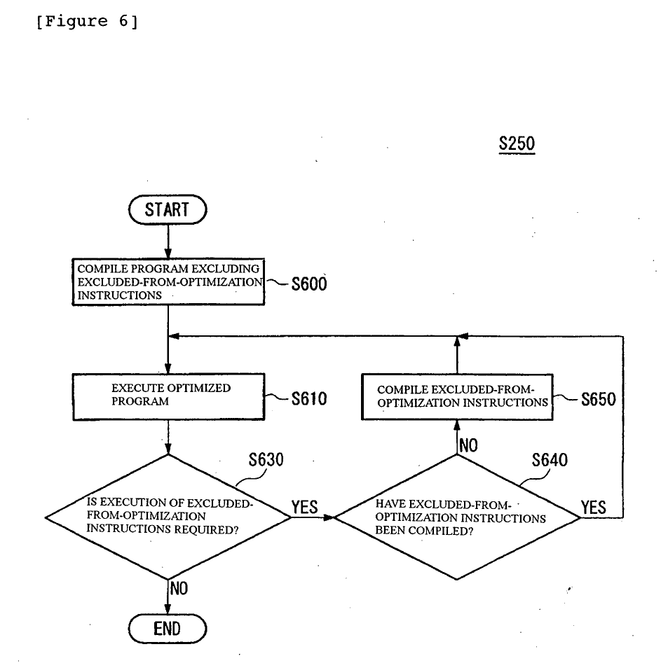

FIG. 6 shows a flowchart of a process performed at S250 shown in FIG. 2. The optimizing unit 160 compiles the target program, excluding the set of excluded-from-optimization instructions which is not part of the set of optimization-target instruction (S600). In particular, the optimizing unit 160 changes the target of the branch instruction that causes a branch from an optimization-target instruction to an excluded-from-optimization instruction, from the top of the basic block of the excluded-from-optimization instructions to a new control transfer basic block that contains an instruction that compiles excluded-from-optimization instructions and transfers control to that compiled excluded-from-optimization instruction. Thus, the optimization unit 160 can identify excluded-from-optimization instructions as unreachable by performing reachability analysis, and eliminate them from compilation target.

As an example of optimizing a set of optimization-target instructions in precedence over other instructions, the optimizing unit 160 may perform partial in line expansion. In particular, the optimizing unit 160 performs in line expansion in which an operation in a callee function called from a set of optimization-target instructions in a calling function is included in the calling set of optimization-target instructions and is executed. Thus, if the inline expansion cannot be applied to the entire body of callee functions or methods because the total code size of the caller function or method becomes too large, the optimizing unit 160 can limit the in line expansion to the optimization-target instructions, thereby achieving the inline expansion appropriately. Consequently, the optimizing unit 160 can apply inline expansion to more functions or methods in a set of functions that are likely to be executed frequently.

The optimizing unit 160 may use the technique described in Document 5. According to the technique, the optimizing unit 160 can apply optimizations (for example, Partial Dead Code Elimination and Partial Escape Analysis) only to optimization-target instructions. If the execution for excluded-from-optimization instructions is required, the on-stack replacement technique described in Document 6 may be used to recompile the target program and to transfer the control to an appropriate program point.

The optimizing unit 160 outputs the optimized target program and executes it (S610). The optimizing unit 160 places an instruction causing recompilation in a control transfer basic block. If the execution of excluded-from-optimization instructions becomes required as a result of executing the optimization-target instructions (S630: YES), the optimizing unit 160 determines whether or not the excluded-from-optimization instructions have been compiled (S640). If the excluded-from-optimization instructions have not been compiled yet (S640: NO), the optimizing unit 160 compiles them (S650) and returns to S610, where the target program including the excluded-from-optimization instructions are executed. Alternatively, the optimizing unit 160 may cause an interpreter to execute the excluded-from-optimization instructions. This is accomplished by placing an instruction that transfers control to the interpreter in a control transfer basic block. If the execution of excluded-from-optimization instructions is not required in the course of execution of the optimization-target programs (S630: NO), the optimizing unit 160 terminates without being invoked for recompilation.

In this way, the optimizing unit 160 compiles only optimization-target instructions, thereby reducing the number of instructions to be compiled compared with the one for the original target program. Consequently, the efficiency of execution of the target program can be improved and the speed of execution can be increased. Furthermore, because the number of instructions to be compiled is reduced, the time required for compilation can be reduced.

The optimization for improving the efficiency and/or speed of execution of optimization-target instructions is not limited to the example shown in FIG. 6. For example, if a target program is executed by a device including a main memory with a number of pages and a virtual memory allocating unit that allocates each of the pages to a virtual address accessible to a user, the optimizing unit 160 may place optimization-target instructions in a separate page from those instructions other than the optimization-target instructions. For example, the compiler apparatus 10 may use the Method Splitting technique described in Document 2.

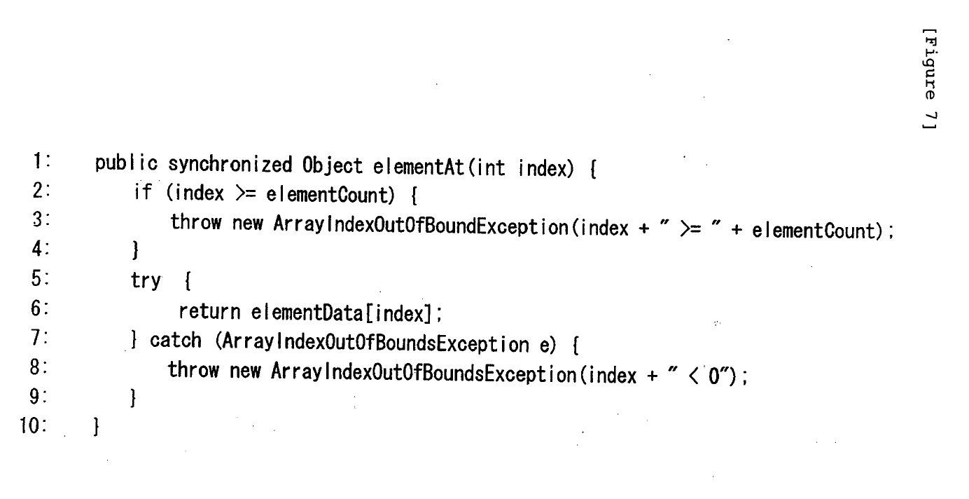

FIG. 7 shows an example of a target program. The target program shown in FIG. 7 has a function (method) called “elementAt” in java/util/Vector class, which is frequently executed in many application programs written in Java® language. This function contains an instruction on the second line for determining whether a predetermined condition is met, an exception generating instruction on the third line for raising an exception if the condition is met, a function returning instruction on the sixth line with the return value of an object within the array variable “elementData[index]”, an exception catch instruction on the seventh line for catching the exception if it is thrown in the instruction on the sixth line, and an instruction on the eighth line for generating another exception if the exception is caught in the instruction on seventh line.

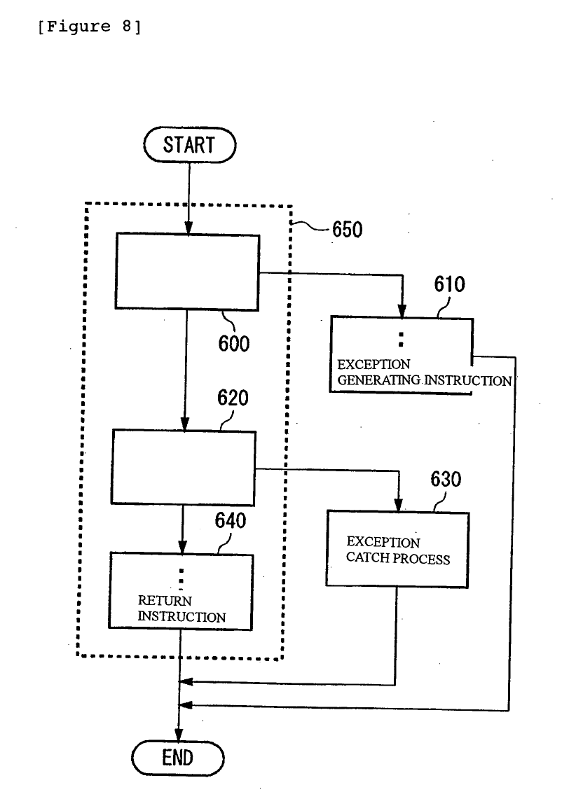

FIG. 8 shows a control flow of the target program shown in FIG. 7. The control flow includes the basic block 600 that makes the conditional check on the second line in FIG. 7 and the basic block 610 that contains an exception generating instruction for generating an exception if the condition in the basic block 600 is met. In addition, the control flow in FIG. 8 includes the basic block 620 that accesses the array variable on the sixth line in FIG. 7, the basic block 630 corresponding to the instruction on the eighth line in FIG. 7, which is an exception catch executed if the index associated with the array variable access falls out if the away bound, and the basic block 640 that includes a return instruction for terminating the function as shown on the sixth line in FIG. 7.

If the compiler apparatus 10 compiles the entire target program, the efficiency and/or speed of execution for the execution path 650 can be decreased due to the presence of the basic blocks 610 and 630 that are rarely executed, and in addition, the code size of the compiled target program can be increased. Therefore, the compiler apparatus 10 performs the following process in order to optimize blocks that are likely to be executed frequently, in precedence over other blocks.

The instruction detecting unit 120 detects as an optimization-target instruction a function terminating instruction. The instruction detecting unit 120 regards the basic block 640 containing the function terminating instruction as a target of optimization. The instruction detecting unit 120 regards the basic blocks 610 and 630, which include the exception generating instruction and the exception catch instruction, respectively, as instructions to be excluded from optimization.

The instruction set selecting unit 130 traverses the execution sequence backward from the optimization-target instruction and selects instructions one by one. In this way, it selects as a set of optimization-target instructions a set of instructions that are executed before the optimization-target instructions detected in the function. In particular, the instruction set selecting unit 130 traverses the execution sequence backward from the basic block 640, selects the basic blocks 620 and 600 in that order, and selects the instructions within the basic blocks 600, 620, and 640 as a set of optimization-target instructions. The instruction set selecting unit 130 also traverses the execution sequence backward from a detected excluded-from-optimization instruction and selects instructions until it reaches the set of optimization-target instructions. In this way, it selects a set of excluded-from-optimization instructions. For example, the instruction set selecting unit 130 selects instructions as it traverses the execution sequence backward from the exception generating instruction until it reaches the basic block 600, that is, instructions in the basic block 610, as excluded-from-optimization instructions.

The optimizing unit 160 optimizes the program so that the rate of improvement, by optimization, in speed of execution of the execution path 650 in which the selected optimization-target instructions are sequentially executed becomes hither than the rate of improvement, by optimization, in execution speed of the excluded-from-optimization instructions, namely the basic blocks 610 and 630. Thus, the optimizing unit 160 can optimize the execution path 650, in which the selected optimization-target instructions are sequentially executed, so that it is executed more efficiently than the excluded-from-optimization, namely the basic blocks 610 and 630.

In this way, the compiler apparatus 10 selects an instruction such as a return instruction that is likely to be executed frequently as an optimization-target instruction and detects an instruction such as an exception generating instruction that is likely to be executed infrequently as an excluded-from-optimization instruction. Then, the compiler apparatus 10 selects the execution path leading to the instructions as a set of optimization-target instructions or a set of excluded-from-optimization instructions. Thus, the compiler apparatus 10 can properly select a path to be optimized even if the execution frequency of each execution path in the target program cannot be measured.

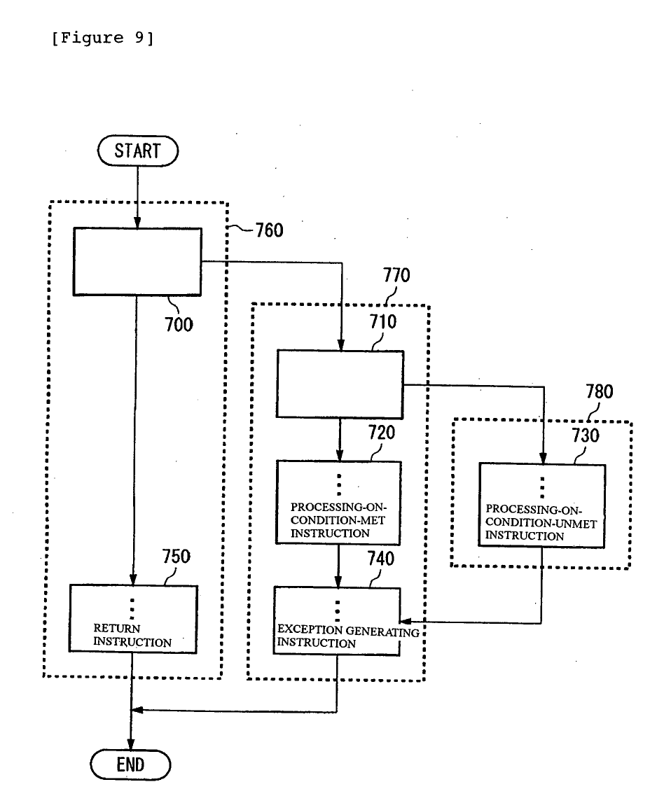

FIG. 9 is a diagram illustrating an operation of a variation. FIG. 9 shows a control flow of a target program, which differs from the one shown in FIG. 8. In this example, the execution frequency of the instructions in the basic block 740 has been measured by the execution frequency information measuring unit 100. The execution frequency falls within the range between the predetermined first threshold and the second threshold. The instruction detecting unit 120 detects a return instruction in a basic block 750 as an optimization-target instruction. The instruction detecting unit 120 also detects instructions of another type in the target program, for example an exception generating instruction in the basic block 740 whose execution frequency, measured by the execution frequency information measuring unit 100, falls within the range between the first and second thresholds, as sub-optimization-target instructions to which precedence in optimization is given over excluded-from-optimization instructions that are excluded from the set of optimization-target instructions but not over the optimization-target instructions. In addition, the instruction detecting unit 120 detects instructions in the basic block 730 which is executed when a condition in the basic block 710 is not met, as excluded-from-optimization-instructions.

Then the instruction set selecting unit 130 selects instructions one by one by traversing the execution sequence backward from the return instruction. Thus, the instruction set selecting unit 130 selects the instructions in the basic block 750 as a set of optimization-target instructions. Furthermore, the instruction set selecting unit 130 selects, as a set of optimization-target instruction, instructions (for example, those in the basic block 700) that have the execution order determined with respect to each of the optimization-target instructions and sub-optimization-target instructions and are executed prior to each of the optimization-target instructions and sub-optimization-target instructions. This means that the execution path 760 becomes the execution path along which the optimization-target instructions are sequentially executed.

The instruction set selecting unit 130 also selects instructions, for example the instructions in basic blocks 710, 720, and 740, whose execution order is determined with the sub-optimization-target instructions and not determined with respect to the optimization-target instructions. Accordingly, the execution path 770 becomes the execution path along which the sub-optimization-target instructions are executed. Furthermore, the instruction set selecting unit 130 traverses the execution path backward from a processing-on-condition-unmet instruction until the basic block 710 and selects the set of instructions along the path, that is, instructions in the basic block 730, as a set of excluded-from-optimization instructions. Accordingly, the execution path 780 becomes the execution path along which the excluded-from-optimization instructions are executed.

Then, the optimizing unit 160 optimizes the target program so that the rate of improvement in speed of execution of the sub-optimization-target instructions becomes lower than the rate of improvement in speed of execution of the optimization-target instructions but higher than the improvement in speed of execution of the excluded-from-optimization instructions. Thus, the optimizing unit 160 optimizes the sub-optimization-target instructions so that they are executed with a moderate efficiency, that is lower than that of the optimization-target instructions but higher than that of the excluded-from-optimization instructions.

As described in the present variation, the compiler apparatus 10 may detect sub-optimization-target instructions, in addition to optimization-target instructions and excluded-from-optimization instructions, depending on the type of the instructions. Consequently, the compiler apparatus 10 can set the precedence of optimization to a finer degree for each execution path in the target program.

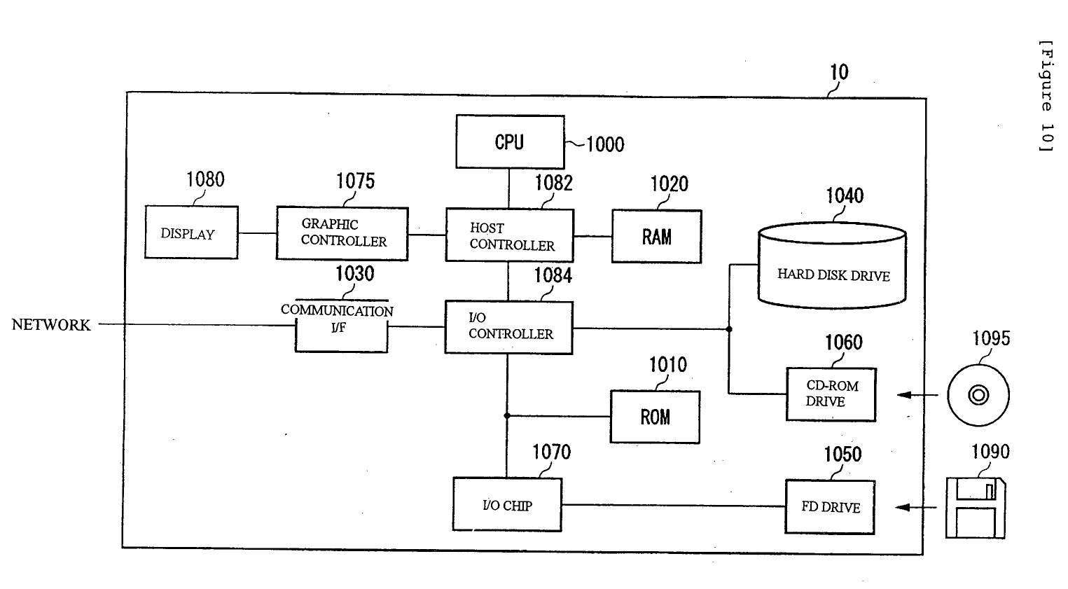

FIG. 10 shows an example of a hardware configuration of the compiler apparatus 10. The compiler apparatus 10 comprises a CPU section including a CPU 1000, a RAM 1020, a graphic controller 1075, and a display 1080, which are interconnected through host controller 1082, an input-output section including a communication interface 1030, a hard disk drive 1040, and a CD-ROM drive 1060, which are connected to the host controller 1082 through an input-output controller 1084, and a legacy input-output section including a ROM 1010, a flexible disk drive 1050, and an input-output chip 1070, which are connected to the input-output controller 1084.

The host controller 1082 connects the RAM 1020 with the CPU 1000 and the graphic controller 1075, which access the RAM at a higher transfer rate. The CPU 1000 operates according to a compiler program stored in the ROM 1010 and the RAM 1020 to control each component. The graphic controller 1075 obtains image data generated by the CPU 1000 and the like on a frame buffer in the RAM 1020 and puts it on the display 1080. The graphic controller 1075 may contain a frame buffer within it for storing image data generated by the CPU 1000 and the like.

The input-output controller 1084 connects the host controller 1082 with the communication interface 1030, hard disk drive 1040, and CD-ROM drove 1060, which are relatively fast input/output devices. The communication interface 1030 communicates with other devices through a network. The hard disk drive 1040 stores the compiler program and data used by the compiler apparatus 10. The CD-ROM drive 1060 reads the compiler program or data from the CD-ROM 1095 and provides it to the input-output chip through the RAM 1020.

Connected to the input-output controller 1084 are the ROM 1010 and relatively slow input/output devices such as, flexible disk drive 1050 and input-output chips 1070. The ROM 1010 stores a boot program executed by the CPU 1000 on activation of the compiler apparatus 10 and programs that are dependent on the hardware of the compiler apparatus 10. The flexible disk drive 1050 reads the compiler program or data from the flexible disk 1090 and provides it to the input-output chip 1070 through the RAM 1020. The input-output chip 1070 provides connection to input/output devices through a flexible disc 1090 and others, such as parallel port, serial port, keyboard port, and mouse port.

The compiler program to be provided to the compiler apparatus 10 is stored in a storage medium such as a flexible disk 1090, CD-ROM 1095, or IC card and provided by a user. The compiler program is read from the storage medium, installed in the compiler apparatus 10 through the input-output chip 1070, and executed in the compiler apparatus 10.

The compiler program installed and executed in the compiler apparatus 10 comprises an execution frequency information measuring module, a processing instruction duplicating module, an instruction detecting module, an instruction set selecting module, an execution information propagating module, a branch instruction propagating module, and an optimizing module. These modules cause the compiler apparatus 10 to perform the same operations as those performed by their corresponding units in the compiler apparatus 10 which have been described with respect to FIGS. 1 to 9. Therefore the description of these modules will be omitted herein.

The compiler program or the modules mentioned above may be stored in an external storage medium. The storage medium may be an optical storage medium such as a DVD and PD, a magneto-optical storage medium such as a MD, a tape medium, and a semiconductor memory such as an IC card, as well as a flexible disk 1090 and a CD-ROM 1095. Alternatively, the program may be stored in a storage device such as a hard disk or RAM provided in a server system connected to a private communication network or the Internet and provided to the compiler apparatus 10 over the network.

As has been described, the compiler apparatus 10 predetermines instructions that are likely to be executed frequently and detects such instructions as optimization-target instructions. Then, the compiler apparatus 10 traverses an execution sequence backward from the optimization-target instructions to select a set of optimization-target instructions and optimizes them in precedence over other instructions. Consequently, the compiler apparatus 10 can select a set of optimization-target instructions properly even if it cannot measure the frequency of execution of all instructions beforehand. Therefore, the compiler apparatus 10 can focus the optimization effort on instructions that are frequently executed, and thus can reduce the time required for compilation.

If the actual frequency of execution of at least a part of a target program can be measured, the compiler apparatus 10 determine the frequency of execution of the other parts of the program on the basis of the measured execution frequency. Thus, the compiler apparatus 10 can effectively use incomplete information about the execution frequency.

### Advantages of the Invention

As can be seen from the foregoing description, instructions to be optimized in precedence over other instructions can be properly selected according to the present invention.

### Description of Symbols

10 . . . Compiler apparatus

100 . . . Execution frequency information measuring unit

110 . . . Processing instruction duplicating unit

120 . . . Instruction detecting unit

130 . . . Instruction set selecting unit

140 . . . Execution information propagating unit

150 . . . Branch instruction propagating unit

160 . . . Optimizing unit

600 . . . Basic block

610 . . . Basic block

620 . . . Basic block

630 . . . Basic block

640 . . . Basic block

650 . . . Execution path

700 . . . Basic block

710 . . . Basic block

720 . . . Basic block

730 . . . Basic block

740 . . . Basic block

750 . . . Basic block

760 . . . Execution path

770 . . . Execution path

780 . . . Execution path

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

Having thus described the invention, what is claimed as new and desired to be secured by Letters Patent is as follows:

1. A compiler apparatus that optimizes a target program to be compiled, comprising:
an instruction detecting unit for detecting an instruction of a predetermined type as an optimization-target instruction to be optimized in precedence over other instructions in said target program;
an instruction set selecting unit for selecting a set of optimization-target instructions, said set being a set of instructions the order of execution of which is determined with respect to said detected optimization-target instruction and being executed before said optimization-target instruction; and
an optimizing unit for optimizing said target program so that the rate of improvement in speed of execution of said optimization-target instruction set by optimization becomes higher than the rate of improvement in speed of execution of a set of instructions other than said optimization-target instruction set by optimization.

2. The compiler apparatus according to claim 1, wherein:
said target program includes at least one function;
said instruction detecting unit detects as said optimization-target instruction a function end instruction that ends said function; and
said instruction set selecting unit selects as said optimization-target instruction set a set of instructions that are executed before said optimization-target instruction in said function.

3. The compiler apparatus according to claim 1, wherein:
said instruction detecting unit further detects an instruction of another predetermined type as an excluded-from-optimization instruction to be excluded from a target to be optimized in precedence over other instructions;
said instruction set selecting unit selects as said optimization-target instruction set a set of instructions that have not been selected as said excluded-from-optimization instruction from among instructions the order of execution of which is determined with respect to said optimization-target instruction and that are executed before said optimization-target instruction.

4. The compiler apparatus according to claim 3, wherein:
if a predetermined exception generating condition is met, said target program proceeds to an exception catch process appropriate to the type of said exception generating condition; and
said instruction detecting unit detects as said excluded-from-optimization instruction said exception generating instruction that causes said target program to proceed to said exception catch process during execution of said target program.

5. The compiler apparatus according to claim 3, wherein:
if a predetermined exception generating condition is met, said target program proceeds to an exception catch process appropriate to the type of said exception generating condition; and
said instruction detecting unit detects as said excluded-from-optimization instruction any of instructions included in said exception catch process.

6. The compiler apparatus according to claim 3, wherein said target program includes a data reference instruction that refers to data;
if said data reference instruction is executed in a reference-unsolved state in which the storage location of the data to be referred to has not been analyzed, said data reference instruction is translated into a direct reference instruction including information indicating the storage location of the data to be referred to; and
said instruction detecting unit detects said data reference instruction in said reference-unsolved state as said excluded-from-optimization instruction.

7. The compiler apparatus according to claim 3, wherein:
said target program includes a processing instruction that has a predetermined parameter as an input and performs a process according to said parameter;
said compiler apparatus further comprises a processing instruction duplicating unit for generating, in place of said processing instruction, a processing-on-condition-met instruction that performs the same process as said processing instruction and is executed faster than said processing instruction if said parameter meets a predetermined condition, and a processing-on-condition-unmet instruction that is executed if said parameter does not meet said predetermined condition; and
said instruction detecting unit detects said processing-on-condition-unmet instruction as said excluded-from-optimization instruction.

8. The compiler apparatus according to claim 3, wherein said instruction set selecting unit comprises:
an execution information propagating unit that detects, as an excluded-from-optimization instruction, an instruction that is executed immediately before said excluded-from-optimization instruction, and detects, as an optimization-target instruction, an instruction that is executed immediately before said optimization-target instruction; and
a branch instruction propagating unit that detects, as an optimization-target instruction, a branch instruction any of the branch target instructions of which is said optimization-target instruction, and detects, as an excluded-from-optimization instruction, a branch instruction none of the branch target instructions of which is said optimization-target instruction and any of the branch target instructions is said excluded-from-optimization instruction,; and
said compiler apparatus selects, as said optimization-target instruction set, a set of said optimization-target instructions detected by applying the process performed by said execution information propagating unit and said branch instruction propagating unit to the instructions in said target program one by one.

9. The compiler apparatus according to claim 3, further comprising an execution frequency information measuring unit that measures the frequency of execution of at least some of the instructions included in said target program by executing said target program; wherein:
if said frequency of execution of said detected excluded-from-optimization instruction that is measured by said execution frequency information measuring unit is higher than a predetermined first frequency, said instruction set selecting unit selects the excluded-from-optimization instruction as said optimization-target instruction, and if said frequency of execution of said detected optimization-target instruction that is measured by said execution frequency information measuring unit is lower than a predetermined second frequency lower then said first frequency, said instruction set selecting unit selects the optimization-target instruction as said excluded-from-optimization instruction.

10. The compiler apparatus according to claim 1, wherein said instruction set selecting units follows an execution sequence backward from said detected optimization-target instruction to select said optimization-target instruction set; and
said optimizing unit optimizes the target program so that the rate of improvement in speed of execution of said selected optimization-target instruction set by optimization of an execution path becomes higher than the rate of improvement in speed of execution of the instructions other than said optimization-target instructions.

11. The compiler apparatus according to claim 1, wherein, in order to compile said target program so that the rate of improvement in speed of execution of said optimization-target instruction set by optimization becomes higher than the rate of improvement in speed of the instructions other than said optimization-target instruction set by optimization, said optimizing unit compiles said target program excluding said excluded-from-optimization instruction set other than said optimization-target instruction set, then causes said target program to be executed and, if execution of said excluded-from-optimization instruction set becomes required as a result of the execution of said optimization-target instruction set, compiles said excluded-from-optimization instruction set.

12. The compiler apparatus according to claim 1, wherein the target program is executed by a device including a main memory having a plurality of pages and a virtual memory allocating unit for allocating each of the plurality of pages to an virtual address accessible to a user;
said optimizing unit places the optimization-target instruction set in one of the plurality of page that is different from a page in which the instructions other than the optimization-target instruction set are placed and thereby optimizes the target program so that the rate of improvement in speed of execution of the optimization-target instruction set by optimization becomes higher than the rate of improvement in speed of execution of instructions other than the optimization-target instruction set by optimization.

13. The compiler apparatus according to claim 1, wherein, in order to compile said target program so that the rate of improvement in speed of execution of said optimization-target instruction set by optimization becomes higher than the rate of improvement in speed of the instructions other than said optimization-target instruction set by optimization, said optimizing unit performs in-line expansion in which an operation in a function called from an optimization-target instruction set in a calling function in said target program excluding the excluded-from-optimization instruction set is included in an optimization-target instruction set in the calling function and is executed.

14. The compiler apparatus according to claim 1, wherein said instruction detecting unit further detects instructions of another predetermined type, as sub-optimization-target instructions to be optimized not in precedence over said optimization-target instructions but in precedence over the excluded-from-optimization instructions that are excluded from the target to be optimized in precedence;
said instruction set selecting unit selects, as said optimization-target instruction set, a set of instructions the order of execution of which is determined with respect to said optimization-target instructions and said sub-optimization-target instructions and that are executed before said optimization-target instructions and said sub-optimization-target instructions, and selects, as a set of sub-optimization-target instructions, a set of instruction the order of execution of which is determined with respect to said sub-optimization-target instructions but not determined with respect to said optimization-target instructions; and
said optimizing unit optimizes said target program so that the rate of improvement in speed of execution of said sub-optimization-target instruction set by optimization becomes lower than the rate of improvement in speed of execution of the rate of improvement in speed of execution of said optimization-target instruction set by optimization but higher than the rate of improvement in speed of execution of said excluded-from-optimization instructions by optimization.

15. The compiler apparatus according to claim 14, further comprising an execution frequency information measuring unit for measuring the frequency of execution of at least some of instructions in said target program by executing said target program;
wherein said instruction detecting unit detects, as said sub-optimization target instructions, instructions of another predetermined type in said target program on further condition that the execution frequency which is measured by said execution frequency information measuring unit is within a predetermined range.

16. A compiler apparatus that optimizes a target program to be compiled, comprising:
an instruction detecting unit for detecting an instruction of a predetermined type that is to be excluded from targets to be optimized in precedence over other instructions in said target program;
an instruction set selecting unit for selecting a set of excluded-from-optimization instructions to be excluded from targets to be optimized in precedence by sequentially selecting the instructions while following an execution sequence backward from said detected optimization-target instruction until an instruction predetermined as a target of optimization is found;
an optimizing unit for optimizing said target program so that the rate of improvement in speed of execution of a set of instructions other than said excluded-from-optimization instructions by optimization becomes higher than the rate of improvement in speed of execution of said excluded-from-optimization instructions by optimization.

17. A compiling method that optimized a target program to be compiled, comprising the steps of:
detecting an instruction of a predetermined type as an optimization-target instruction to be optimized in precedence over other instructions in said target program;
selecting a set of optimization-target instructions, said set being a set of instructions the order of execution of which is determined with respect to said detected optimization-target instruction and being executed before said optimization-target instruction; and
optimizing said target program so that the rate of improvement in speed of execution of said optimization-target instruction set by optimization becomes higher than the rate of improvement in speed of execution of a set of instructions other than said optimization-target instruction set by optimization.

18. A compiling method that optimized a target program to be compiled, comprising the steps of:
detecting an instruction of a predetermined type as an excluded-from optimization instruction to be excluded from targets to be optimized in precedence over other instructions in said target program;
performing a selecting step for selecting a set of excluded-from-optimization instructions to be excluded from targets to be optimized in precedence by sequentially selecting the instructions while following an execution sequence backward from said detected optimization-target instruction until an instruction predetermined as a target of optimization is found;
optimizing said target program so that the rate of improvement in speed of execution of a set of instructions other than said excluded-from-optimization instructions by optimization becomes higher than the rate of improvement in speed of execution of said excluded-from-optimization instructions.

19. A compiler program for causing a computer to function as a compiler apparatus that optimizes a target program to be compiled; said compiler program causing said computer to function as:
an instruction detecting unit for detecting an instruction of a predetermined type as an optimization-target instruction to be optimized in precedence over other instructions in said target program;
an instruction set selecting unit for selecting a set of optimization-target instructions, said set being a set of instructions the order of execution of which is determined with respect to said detected optimization-target instruction and being executed before said optimization-target instruction; and
an optimizing unit for optimizing said target program so that the rate of improvement in speed of execution of said optimization-target instruction set by optimization becomes higher than the rate of improvement in speed of execution of a set of instructions other than said optimization-target instruction set by optimization.

20. The compiler program according to claim 19, wherein said instruction detecting unit further detects an instruction of another predetermined type as excluded-from-optimization instruction to be excluded from a target to be optimized in precedence over other instructions; and
said instruction set selecting unit selects as said optimization-target instruction set a set of instructions that have not been selected as said excluded-from-optimization instruction from among instructions the order of execution of which is determined with respect to said optimization-target instruction and that are executed before said optimization-target instruction.

21. A compiler program for causing a computer to function as a compiler apparatus that optimizes a target program to be compiled; said compiler program causing said computer to function as:
an instruction detecting unit for detecting an instruction of a predetermined type as an excluded-from-optimization instruction to be excluded from targets to be optimized in precedence over other instructions in said target program;
an instruction set selecting unit for selecting a set of excluded-from-optimization instructions to be excluded from targets to be optimized in precedence by sequentially selecting the instructions while following an execution sequence backward from said detected excluded-from-optimization instruction until an instruction predetermined as a target of optimization is found; and
an optimizing unit for optimizing said target program so that the rate of improvement in speed of execution of a set of instructions other than said excluded-from-optimization instructions by optimization becomes higher than the rate of improvement in speed of execution of said excluded-from-optimization instructions by optimization.

22. A storage medium containing the compiler program according to claim 19.

23. A storage medium containing the compiler program according to claim 20.

24. A storage medium containing the compiler program according to claim 21.
